(19) United States
(12) Patent Application Publication
(10) Pub. No.: US 2012/0154976 A1
(43) Pub. Date: Jun. 21, 2012

(54) CONDUCTIVE PASTE COMPOSITION FOR INNER ELECTRODE, LAMINATED CERAMIC ELECTRONIC PART USING THE SAME AND MANUFACTURING METHOD THEREOF

(75) Inventors: Jai Joon LEE, Seoul (KR); Hyun Chul Jung, Yongin (KR); Jae Man Park, Suwon (KR); Jong Han Kim, Suwon (KR)

(73) Assignee: SAMSUNG ELECTRO-MECHANICS CO., LTD.

(21) Appl. No.: 13/325,384

(22) Filed: Dec. 14, 2011

(30) Foreign Application Priority Data
Dec. 15, 2010 (KR) 10-2010-0128307

(51) Int. Cl. H01G 4/30; B05D 5/12; H01B 1/02

(52) U.S. Cl. 361/301.4; 252/512; 252/514; 252/513; 427/79

(57) ABSTRACT

There are provided a conductive paste composition for an inner electrode, and a laminated ceramic electronic part and a manufacturing method thereof using the conductive paste composition. The conductive paste composition includes metal powder coated with an organosilica compound formed by polymerization of an organosilane compound having a structure of RₙSi(OR′)₄₋ₙ (wherein R is selected from alkyl and aryl groups, each having 20 or less carbon atoms, R′ is any one of the alkyl groups having 4 or less carbon atoms, and n is 1 or 2). Since the organosilica coating layer is coated around the metal powder particles, preventing the metal powder particles from being agglomerated, thereby allowing the conductive paste composition having very superior dispersibility to be manufactured. In addition, effects such as inhibited oxidation of the metal powder during plasticization and effectively inhibited shrinkage of the metal powder during sintering may be accomplished.

### CROSS-REFERENCE TO RELATED APPLICATIONS

This application claims the priority of Korean Patent Application No. 10-2010-0128307 filed on Dec. 15, 2010, in the Korean Intellectual Property Office, the disclosure of which is incorporated herein by reference.

### BACKGROUND OF THE INVENTION

1. Field of the Invention

The present invention relates to a conductive paste composition for an inner electrode, having excellent dispersibility and capable of efficiently preventing contraction during sintering, a laminated ceramic electronic part using the same and a manufacturing method thereof.

2. Description of the Related Art

In general, laminated ceramic electronic parts are mounted on printed circuit boards for various electronic products such as mobile communication terminals, laptop computers, desktop computers, personal digital assistants (PDA), or the like, and may have a wide range of sizes and a variety of laminated shapes according to the intended purpose and capacity thereof.

In general, powder made from materials such as nickel, copper, or the like, rather than noble metal powder made from materials such as palladium, silver, or the like, is most widely used as a conductive powder of a conductive paste employed in fabricating an inner electrode which is provided on laminated ceramic electronic parts.

Recently, in response to demands for reduction in the size of laminated ceramic electronic parts and an increase in the capacity thereof, there has been a requirement for a fine metal powder having fine metal particles as a conductive powder. The fine metal powder generally shows high activity and has an extremely low sintering initiation temperature.

Since nickel-based fine metal powder begins to shrink at a relatively low temperature, due to oxidation and reduction of nickel, a difference in shrinkage rates between an electrode layer containing the metal powder and a ceramic layer is considerably increased, thus causing structural defects such as delamination, cracking, etc. and limitations in the reliability of electronic parts.

Moreover, with a decrease in the particle size of the metal powder, metal powder particles, during the production of a paste for inner electrode may be agglomerated, thereby causing a deterioration in the dispersibility of the metal powder.

### SUMMARY OF THE INVENTION

An aspect of the present invention provides a conductive paste composition for an inner electrode having excellent dispersibility and capable of efficiently preventing shrinkage during sintering, laminated ceramic electronic parts using the same and a manufacturing method thereof.

According to an aspect of the present invention, there is provided a conductive paste composition for an inner electrode, including: metal powder coated with an organosilica compound formed by polymerization of an organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2).

The metal powder may be at least one selected from a group consisting of silver (Ag), lead (Pb), platinum (Pt), nickel (Ni) and copper (Cu).

A content of the organosilica compound may range from 0.05 to 5.0 parts by weight (wt. parts), in terms of a silica compound (SiO₂), in relation to 100 wt. parts of the metal powder.

According to another aspect of the present invention, there is provided a method of preparing a conductive paste composition for an inner electrode, including: dissolving an organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2) in alcohol; adding metal powder and a solvent to the alcohol to prepare a mixture; removing the alcohol from the mixture; and forming an organosilica compound coating layer on a surface of the metal powder.

The metal powder may be at least one selected from a group consisting of Ag, Pb, Pt, Ni and Cu.

A content of the organosilica compound may range from 0.05 to 5.0 wt. parts, in terms of s silica compound (SiO₂), in relation to 100 wt. parts of the metal powder.

Water or acetic acid may be further added during the dissolving of the organosilane compound in alcohol.

The solvent used in the present invention may be added in an amount of 5 to 50 wt. parts in relation to 100 wt. parts of the metal powder.

The removal of alcohol from the mixture may be conducted by vacuum distillation.

The forming of the organosilica coating layer on the surface of the metal powder may be performed by dehydration-polymerization of the mixture after removing the alcohol from the mixture.

According to another aspect of the present invention, there is provided a laminated ceramic electronic part, including: a ceramic element that has a plurality of dielectric layers laminated therein; inner electrode layers provided on the dielectric layers and formed by using a conductive paste composition, which includes metal powder coated with an organosilica compound formed by polymerization of an organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2); and outer electrodes provided on outer surfaces of the ceramic element and electrically connected to inner electrodes in the internal electrode layers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart illustrating a process of manufacturing a conductive paste composition for an inner electrode according to an exemplary embodiment of the present invention;

FIG. 2 is a schematic view illustrating a coating process of a metal powder surface by using organosilane according to an exemplary embodiment of the present invention;

FIG. 3 is a perspective view illustrating a laminated ceramic capacitor according to an exemplary embodiment of the present invention; and

FIG. 4 is a cross-sectional view taken along lines A-A′ shown in FIG. 3.

### DETAILED DESCRIPTION OF THE PREFERRED EMBODIMENT

Hereinafter, exemplary embodiments will be described in detail with reference to the accompanying drawings. However, other modifications, variations and/or alterations thereof may be possible and the present invention is not particularly limited to the following embodiments. These exemplary embodiments are provided to more clearly understand the present invention by those skilled in the art to which the present invention pertains.

Hereinafter, preferred embodiments of the present invention will be described in detail with reference to the accompanying drawings.

According to an exemplary embodiment of the present invention, a conductive paste composition for an inner electrode includes: metal powder uniformly coated with an organosilica compound formed by polymerization of an organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2).

The metal powder used herein is not particularly limited but may include, for example, silver (Ag), lead (Pb), platinum (Pt), nickel (Ni), copper (Cu), or the like, which are used alone or in combination of two or more thereof.

The organosilane compound has a structure of RₙSi(OR′)₄₋ₙ.

In the structure of the organosilane, R is not particularly limited so long as it is selected from a group consisting of alkyl and aryl groups and preferably an alkyl or aryl group having 20 or less carbon atoms.

For example, each of the alkyl groups may be methyl, ethyl, isopropyl, or the like and each of the aryl groups may be phenyl or the like.

In addition, ‘n’ may be 1 or 2 and, if n is 1, R may be any one selected from alkyl groups such as methyl, ethyl, isopropyl, or the like and the aryl groups such as phenyl or the like.

On the other hand, if n is 2, R may be two identical functional groups selected from alkyl groups such as methyl, ethyl, isopropyl, or the like, and the aryl groups such as phenyl or the like. Otherwise, R may be two difference functional groups selected from the alkyl and aryl groups.

R′ may be anyone selected from alkyl groups, each having 4 or less carbon atoms.

R′ may be any alkyl group without particular limitation so long as the alkyl group has 4 or less carbon atoms, and may include, for example, methyl, ethyl, propyl, butyl or an isomer thereof.

An organosilane precursor generally used as a coupling agent may include, for example, vinyl, epoxy, amino, methacryl, acryl, isocyanato and mercapto, or the like.

If a silane coupling agent selected from the organosilane compounds is used as a raw material of the organosilica coating layer, an organic group (R) such as an epoxy or amine group is hardened by heat or light, or easily reacts with other compounds and then coupled with the same.

As such, since the metal powder may be hardened or a chemical reaction thereof may be caused due to heat or light during coating the metal powder or dispersing the metal powder to form a paste, the paste produced as a final product has defects such as high viscosity, worse surface roughness, or the like.

Therefore, in order to produce a paste with improved surface roughness and stable dispersibility, in an exemplary embodiment of the present invention, the organic group, that is, R, is limited as described above.

In other words, according to the exemplary embodiment of the present invention, there is provided the metal powder uniformly coated with an organosilica compound prepared by using an organosilane compound having a structure of RₙSi(OR′)₄₋ₙ, wherein R has at least one selected from alkyl groups such as methyl, ethyl, isopropyl, or the like and aryl groups such as phenyl or the like.

Therefore, a paste composition for an inner electrode according to an exemplary embodiment of the present invention does not cause polymerization or hardening of the organosilica compound contained therein, so that the past have excellent surface roughness and superior dispersibility due to no increase in viscosity.

The content of the organosilane compound may range from 0.05 to 5.0 parts by weight (wt. parts) in terms of silica compound (SiO₂), in relation with 100 wt. parts of the metal powder.

If the content of the organosilane compound is less than 0.05 wt. parts, an amount of this compound added to the metal powder is too small to completely coat the surface of metal powder particles. Accordingly, the metal powder does not have beneficial features such as excellent dispersibility, inhibited oxidation during plasticization and/or inhibited shrinkage during sintering.

On the other hand, if the content of the organosilane compound exceeds 5.0 wt. parts, particles are naturally formed so that the specific surface area thereof are increased, thus causing difficulties in securing excellent dispersibility of the paste.

The conductive paste composition for an inner electrode according to an exemplary embodiment of the present invention is prepared using the metal powder uniformly coated with the organosilica compound as described above, and therefore, exhibits excellent dispersibility without agglomeration of the metal powder during production of the paste.

That is, when the metal powder uniformly coated with the organosilica compound is used, agglomeration of powder particles does not occur because of the organic group (R) present on the surface of the metal powder, thus enabling the metal powder to be easily dispersed in an organic solvent and a paste binder.

Furthermore, since the organosilica compound is uniformly applied to the metal powder, oxidation and shrinkage of the metal powder may be efficiently delayed during plasticization and sintering thereof, respectively.

In other words, the metal powder coated with the organosilica compound according to the exemplary embodiment of the present invention shows improved oxidation resistance and shrink resistance, thereby enhancing properties of laminated ceramic electronic parts manufactured using the metal powder.

Metal powder formed of a material such as nickel is likely to be oxidized and has a relatively low temperature for sintering shrinkage, compared to ceramic powder. Therefore, the metal powder has limitations in processing when used in manufacturing an inner electrode for a laminated ceramic electronic part.

In particular, in the case of manufacturing ultrathin inner electrodes, nickel powder needs to have a decreased particle diameter. However, when the nickel powder with reduced particle diameter is used for manufacturing the ultrathin inner electrodes, improvement in oxidation and shrink behaviors is absolutely required.

When the metal powder coated with the organosilica compound according to the exemplary embodiment of the present invention is used, the organosilica compound may be uniformly applied to the surface of the metal powder such that an oxidation initiating temperature and a shrink initiating temperature of the metal powder are increased.

Accordingly, in the case of using the metal powder prepared as above, a conductive paste composition for an inner electrode with enhanced properties may be provided.

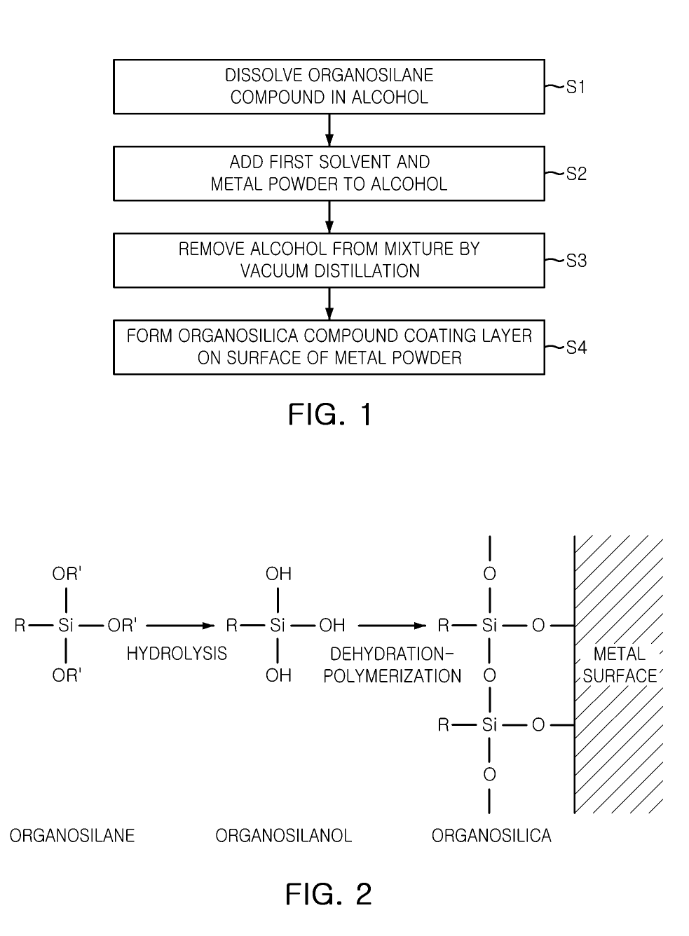

FIG. 1 is a flow chart illustrating a process of manufacturing a conductive paste composition for an inner electrode according to an exemplary embodiment of the present invention.

Referring to FIG. 1, a method for manufacturing a conductive paste composition for an inner electrode according to the exemplary embodiment of the present invention includes: dissolving an organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2) in alcohol (S1); adding metal powder and a first solvent to the above solution to prepare a mixture (S2); removing alcohol from the mixture (S3); and forming an organosilica compound coating layer on a surface of the metal powder (S4).

The following detailed description will be given to explain each of the processes of the foregoing manufacturing method.

First, the organosilane compound is dissolved in alcohol to prepare a solution with a concentration of 0.1 to 0.5% (S1).

The alcohol used herein is any one generally used in the art without particular limitation and may include, for example, ethanol or the like.

The alcohol may be a liquid state having a boiling point of 120° C. or less.

Water may be added to the alcohol and/or a very small amount of acetic acid may be added thereto.

In the presence of water or a weak acid such as acetic acid, the organosilane compound is hydrolyzed to form silanol having a structure of RₙSi(OH)₄₋ₙ.

Next, metal powder and a solvent are added to the prepared solution to be mixed with the solution (S2).

The solvent may be a high boiling point solvent for paste, in order to maintain the stable condition of the mixture when the alcohol is removed from the mixture in a further process.

The high boiling point solvent for paste may be selected from any solvents generally used in the art without particular limitation and may include, for example, terpineol, mentanol, butyl carbitol acetate, or the like.

The solvent may be added in the content of 5 to 50 wt. parts in relation with 100 wt. parts of the metal powder.

If the viscosity of the solution is too high, alcohol may be further added to dilute the solution.

The metal powder is not particularly limited and may include, for example, Ag, Pb, Pt, Ni, Cu, or the like, which may be used alone or in combination of two or more thereof.

The content of the organosilane compound may range from 0.05 to 5.0 wt. parts, in terms of silica compound (SiO₂), in relation with 100 wt. parts of the metal powder.

If the content of the organosilane compound is less than 0.05 wt. parts, an amount of this compound added to the metal powder is too small to completely coat the surface of metal powder particles. Accordingly, the metal powder does not have beneficial features such as excellent dispersibility, inhibited oxidation during plasticization and inhibited shrinkage during sintering.

On the other hand, if the content of the organosilane compound exceeds 5.0 wt. parts, particles are naturally formed so that the specific surface area thereof are increased, thus causing difficulties in securing excellent dispersibility of the paste.

Following this, the alcohol is removed from the mixture (S3), and a coating layer of the organosilica compound is uniformly formed on the surface of the metal powder (S4).

A process of removing the alcohol from the mixture in which the metal powder and the organosilane compound are uniformly mixed is not particularly limited and may be carried out, for example, by vacuum distillation.

While the alcohol is removed, the silanol typed compound having a structure of RₙSi(OH)₄₋ₙ is subjected to dehydration-condensation to form a uniform organosilica coating layer on the surface of the metal powder.

FIG. 2 is a schematic view illustrating a coating process of a metal powder surface by using organosilane according to an exemplary embodiment of the present invention.

Referring to FIG. 2, the organosilane compound is converted into the silanol typed compound having a structure of RₙSi (OH)₄₋ₙ by hydrolysis, and the silanol typed compound is subjected to dehydration condensation, to thereby form a uniform organosilica coating on the metal powder surface.

Last, a slurry containing the metal powder uniformly coated with the organosilica compound is mixed with a binder, a dispersant, an additive or the like, thereby producing a conductive paste composition for an inner electrode.

Since the conductive paste composition for an inner electrode according to an exemplary embodiment of the present invention, as described above, is produced using the metal powder uniformly coated with the organosilica compound, the agglomeration of the metal powder particles does not occur during the preparation of a paste and the paste may show excellent dispersibility.

In other words, when a metal powder having an organosilica compound uniformly coated thereto is used, since organic groups (R) present on the surface of the metal powder are hydrophobic, the metal powder may be easily dispersed in a solvent for paste, which has a high boiling point and low polarity. Accordingly, the agglomeration of the metal powder particles does not occur during the preparation of the paste, and the paste may exhibit excellent dispersibility.

Even if the organic group (R) of the organosilane compound may include an alkyl group or aryl group, agglomeration of organic ingredients may significantly occur during drying thereof, thus dispersibility of the paste may be deteriorated.

Therefore, in order to secure superior dispersibility after coating, the present invention may adopt a solvent exchange method as described above.

Furthermore, since the organosilane compound is uniformly coated to the metal, oxidation and shrinkage of the metal powder during plasticization and sintering may be efficiently delayed.

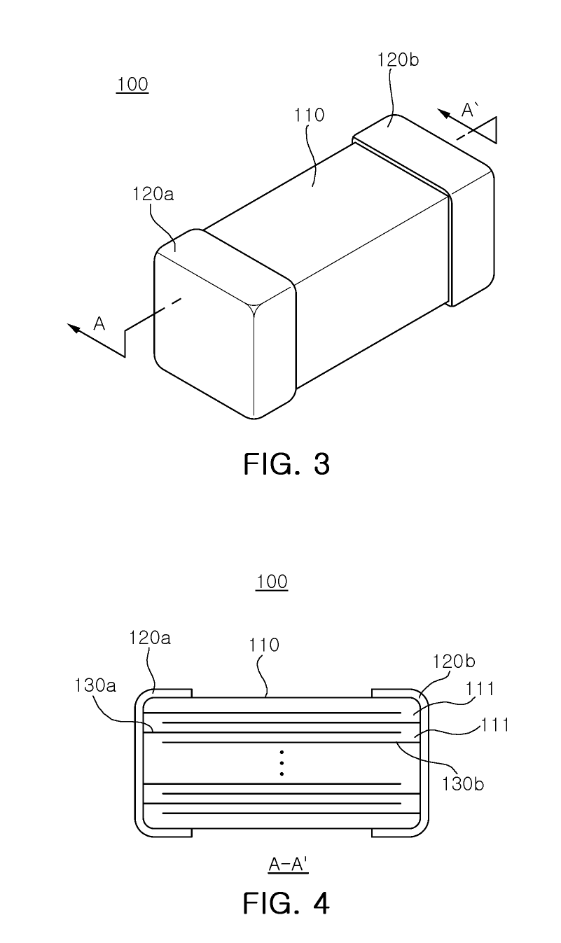

FIG. 3 is a perspective view illustrating a laminated ceramic capacitor according to an exemplary embodiment of the present invention, and FIG. 4 is a cross-sectional view taken along lines A-A′ shown in FIG. 3.

Referring to FIGS. 3 and 4, a laminated ceramic electronic part, includes: a ceramic element 110 having a plurality of dielectric layers 111 sequentially laminated; inner electrode layers 130a and 130b formed on the laminated dielectric layers 111, and made of a conductive paste composition; and outer electrodes 120a and 120b provided on an outer surfaces of the ceramic element 110 and electrically connected to inner electrodes in the inner electrode layers.

The conductive paste composition used herein includes the metal powder uniformly coated with an organosilica compound formed by polymerization of an organosilane compound having a structure of RₙSi(OR′)₄₋ₙ, as described above.

A method for preparing the paste composition is substantially similar to the preparation method of the conductive paste composition according to the above exemplary embodiment of the present invention.

Since a laminated ceramic electronic part, especially, a laminated ceramic capacitor 100, according to an exemplary embodiment of the present invention has the inner electrodes 130a and 130b formed using the metal powder coated with the organosilica compound, it is possible to decrease the thickness of the inner electrode while reducing cracks on the inner electrode, thereby improving reliability of the electronic part.

A method for manufacturing a laminated ceramic electronic part according to an exemplary embodiment of the present invention includes: preparing metal powder coated with an organosilica compound formed by polymerization of an organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2); dispersing the metal powder in a solvent to obtain a conductive paste; applying the conductive paste to a plurality of green sheets to form inner electrode layers; laminating the green sheets, on which the inner electrode layers are formed, to form a laminate; pressing and cutting the laminate to fabricate a green chip; firing the green chip to fabricate a ceramic element.

First, the metal powder uniformly coated with the organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2) is prepared.

The metal powder uniformly coated with the organosilane compound may be prepared by the same method as in the foregoing exemplary embodiment of the present invention.

Next, the metal powder is dispersed in a solvent to prepare a conductive paste.

The preparation of the conductive paste is performed by conventional methods, except that the metal powder uniformly coated with the organosilane compound prepared according to the exemplary embodiment of the present invention is introduced into the solvent.

Subsequently, a laminated ceramic electronic part is fabricated using the conductive paste. In particular, the following description will be given to explain a process of fabricating the laminated ceramic capacitor 100.

(a) A plurality of green sheets may be prepared.

The green sheets are ceramic sheets prepared in a thickness of several micrometers (μm) by a process comprising: blending powder such as barium titanate (BaTiO₃) or the like with a ceramic additive, an organic solvent, a plasticizer, a binder and a dispersant; forming a slurry through the use of a basket mill; applying the slurry to a carrier film; and drying the coated film. This green sheets form dielectric layers 111.

(b) Then, through the use of a conductive paste for an inner electrode, the inner electrode layers 130a and 130b are formed on the green sheet.

More particularly, in step (b), the inner electrode layers 130a and 130b are formed by moving a squeegee in a predetermined direction while dispensing the conductive paste.

(c) After formation of the inner electrode layers 130a and 130b, the green sheets are removed from the carrier film and sequentially laminated to form a laminate.

Following this, (d) after pressing the green sheet laminate at a high temperature under high pressure, (e) the pressed sheet type laminate is cut into pieces with a predetermined size, thereby (f) resulting in a green chip.

Hereafter, a ceramic element 110 is produced from the green chip by plasticization, calcination and polishing processes, followed by provision of outer electrodes 120a and 120b and a plating process, thus completing fabrication of a laminated ceramic electronic part, especially, the laminated ceramic capacitor 100 as described above.

As for the laminated ceramic capacitor 100 according to the exemplary embodiment of the present invention, since the inner electrode layers 130a and 130b are formed by using the metal powder having an organosilane compound coated to the surface of the metal powder, an inner electrode may have decreased thickness and cracks on the inner electrode may be reduced, thereby improving reliability of the capacitor.

As set for above, according to the exemplary embodiments of the present invention, since the organosilica coating layer is coated around the metal powder particles, preventing the metal powder particles from being agglomerated, thereby allowing the conductive paste composition having very superior dispersibility to be manufactured.

In addition, effects such as inhibited oxidation of the metal powder during plasticization and effectively inhibited shrinkage of the metal powder during sintering may be accomplished.

The present invention is not particularly limited to the above preferred embodiments as well as the accompanying drawings but defined by the appended claims. Therefore, it will be apparent to those skilled in the art that various substitutions, modifications and/or variations can be made without departing from the spirit and scope of the invention, and duly included within the present invention.

What is claimed is:

1. A conductive paste composition for an inner electrode, the conductive paste composition comprising:
metal powder coated with an organosilica compound formed by polymerization of an organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2).

2. The conductive paste composition of claim 1, wherein the metal powder is at least one selected from a group consisting of silver (Ag) lead (Pb) platinum (Pt) nickel (Ni) and copper (Cu).

3. The conductive paste composition of claim 1, wherein a content of the organosilane compound ranges from 0.05 to 5.0 parts by weight (wt. parts) in terms of a silica compound (SiO₂) in relation to 100 wt. parts of the metal powder.

4. A method for preparing a conductive paste composition for an inner electrode, comprising:
dissolving an organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2) in alcohol;
adding metal powder and a solvent to a solution containing the alcohol and the organosilane compound dissolved therein, to thereby prepare a mixture;
removing the alcohol from the mixture; and
forming an organosilica compound coating layer on a surface of the metal powder.

5. The method of claim 4, wherein the metal powder is at least one selected from a group consisting of Ag, Pb, Pt, Ni and Cu.

6. The method of claim 4, wherein a content of the organosilane compound ranges from 0.05 to 5.0 wt. parts, in terms of s silica compound (SiO₂), in relation to 100 wt. parts of the metal powder.

7. The method of claim 4, wherein water or acetic acid is further added during the dissolving of the organosilane compound in the alcohol.

8. The method of claim 4, wherein the solvent is added in an amount of 5 to 50 wt. parts in relation to 100 wt. parts of the metal powder.

9. The method of claim 4, wherein the removing of the alcohol from the mixture is performed by vacuum distillation.

10. The method of claim 4, wherein the forming of the organosilica coating layer on the surface of the metal powder is performed by dehydration-polymerization of the mixture after removing the alcohol from the mixture.

11. A laminated ceramic electronic part, comprising:
a ceramic element that has a plurality of dielectric layers laminated therein;
inner electrode layers provided on the dielectric layers and formed by using a conductive paste composition, which includes metal powder coated with an organosilica compound formed by polymerization of an organosilane compound having a structure of RₙSi(OR′)₄₋ₙ (wherein R is selected from alkyl and aryl groups, each having 20 or less carbon atoms, R′ is any one of alkyl groups having 4 or less carbon atoms, and n is 1 or 2); and
outer electrodes provided on outer surfaces of the ceramic element and electrically connected to inner electrodes in the internal electrode layers.
